(19) United States
(12) Patent Application Publication
(10) Pub. No.: US 2021/0029460 A1
(43) Pub. Date: Jan. 28, 2021

(54) Speaker box and mobile terminal

(71) Applicant: AAC Technologies Pte. Ltd., Singapore city (SG)

(72) Inventors: Xingzhi Huang, Shenzhen (CN); Lin Liu, Shenzhen (CN); Dijiang Tong, Shenzhen (CN); Zhe Zhang, Shenzhen (CN); Jun Wu, Shenzhen (CN); Zhichen Chen, Shenzhen (CN); Zhaoyu Yin, Shenzhen (CN)

(21) Appl. No.: 16/995,832

(22) Filed: Aug. 18, 2020

Related U.S. Application Data
(63) Continuation of application No. PCT/CN2019/097419, filed on Jul. 24, 2019.

(30) Foreign Application Priority Data
Jul. 22, 2019 (CN) 201921155219.3

(51) Int. Cl. H04R 9/02; H04R 1/02; H04R 7/12; H04R 9/06

(52) U.S. Cl. CPC H04R 9/022; H04R 1/025; H04R 2499/11; H04R 9/06; H04R 7/12

(57) ABSTRACT

The invention provides a speaker box having an upper cover, a lower cover and a speaker unit. The speaker unit includes a diaphragm engaging with the upper cover for forming a back cavity and a front acoustic cavity. The speaker box also includes a heat conductor conducting the heat generated by a heating part member into the speaker box. The heat conductor is used to conduct the heat generated by the heating part member to the sound channel and the front acoustic cavity. The present application further provides a mobile terminal. The speaker box provided by present application conducts the heat generated by the heating part member of the mobile terminal to outside.

### FIELD OF THE PRESENT DISCLOSURE

The present application relates to electroacoustic transducers, especially to a speaker box with heat dissipation function.

### DESCRIPTION OF RELATED ART

In recent years, with the rapid development of a mobile communication technology, consumers are using a mobile terminal with a voice function more and more. In order to meet the diversification of the mobile terminal function, the workload of a central processor, a circuit board and a battery in the mobile terminal increases significantly, which results in the increase of heat output and affects service life of the mobile terminal and user experience.

Among the related technologies, the mobile terminal comprises a speaker box. No heat exists in the speaker box basically to make the temperature in the speaker box to be kept at low level. At the same time, the speaker box comprises a speaker unit with a diaphragm. The diaphragm is used for vibrating and sounding and useless for the dissipation of heat of a heating part member of the mobile terminal.

### SUMMARY OF THE INVENTION

One object of the present invention is to provide a speaker box with heat dissipation function and improved heat dissipation performance.

Accordingly, the present invention provides a speaker box, comprising:

an upper cover; a lower cover forming a containment space with the upper cover; a speaker unit accommodated in the containment space, comprising a diaphragm for dividing the containment space into a front acoustic cavity and a back cavity opposite to the front acoustic cavity. Wherein the upper cover comprises a top wall opposite to the diaphragm, a side wall bending and extending from an edge of the top wall toward the lower cover, a support wall extending from the top wall to support the speaker unit, and one pair of the blocking plates inclining and extending from the side wall to the support wall. The speaker box further comprises a heat conductor conducting heat generated by a heating part member into the speaker box. The heat conductor extends from the back cavity to the blocking plate and is lapped on the blocking plate; the top wall and the heat conductor together form a sound channel connecting the front acoustic cavity. The heat conductor is used to conduct the heat generated by the heating part member to the sound channel and the front acoustic cavity.

Further, the back cavity is encircled by the heat conductor, the upper cover, the diaphragm and the lower cover.

Further, the heat conductor comprises a heat dissipation part lapped on the blocking plate, a heat conduction part connected with the heating part member and a heat transfer part connecting the heat conduction part and the heat dissipation part; a through hole is set on the side wall; one part of the heat transfer part is accommodated in the containment space; the other part is connected with the heat conduction part through the through hole; the heat conduction part, the heat transfer part and the heat dissipation part are integrally formed.

Further, the two blocking plates comprise an inclined surface set inclinedly to the top wall and the two blocking plates encircle an opening connected with the sound channel with the side wall and the support wall; the heat dissipation part is lapped on the inclined surface and covers the opening completely.

Further, the blocking plate comprises set oppositely a first blocking plate and a second blocking plate; the second blocking plate comprises a body part and an extension part extending from the edge of one side of the body part away from the first blocking plate to the direction near the lower cover; the body part and the extension part cooperate and form a concave groove limiting the heat dissipation part.

Further, the heat conductor has a hollow area for receiving condensate liquid.

Further, the heat conductor is solid structure.

Further, a sound outlet connected with outside is set on the side wall; the sound outlet is connected with the sound channel used for conducting the sound to outside.

The invention further provides a mobile terminal, comprising a housing body with an accommodation space, a heating part member accommodated in the accommodation space and a speaker box as described above accommodated in the accommodation space.

Further, the heating part member is a central processor, a battery or PCB.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of a mobile terminal provided by an embodiment of the present application.

FIG. 2 is an isometric view of a speaker box shown in FIG. 1.

FIG. 3 is an exploded view of the speaker box.

FIG. 4 is an illustration of an upper cover in FIG. 3.

FIG. 5 is an assembled view of the upper cover and a heat conductor.

FIG. 6 is a cross-sectional view of the speaker box taken along line VI-VI in FIG. 2.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

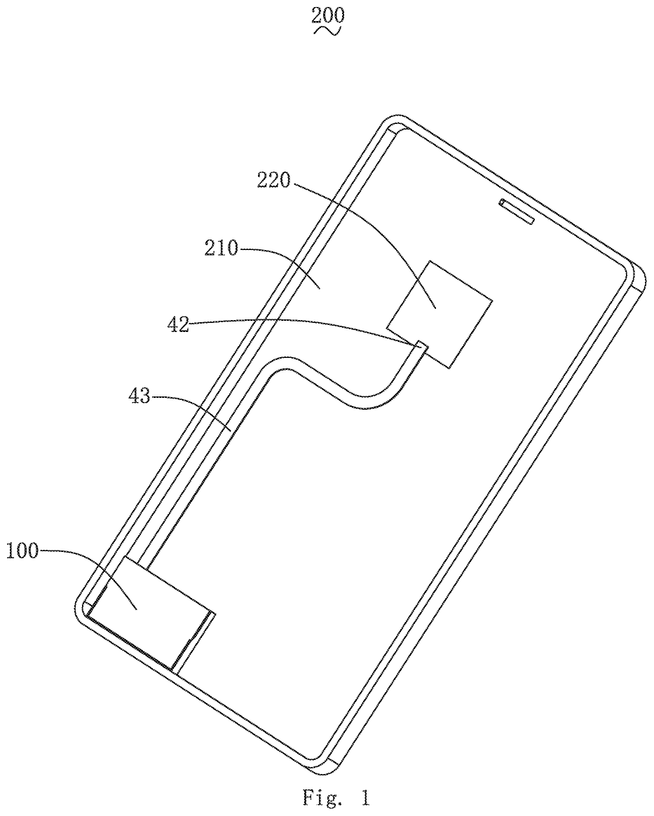

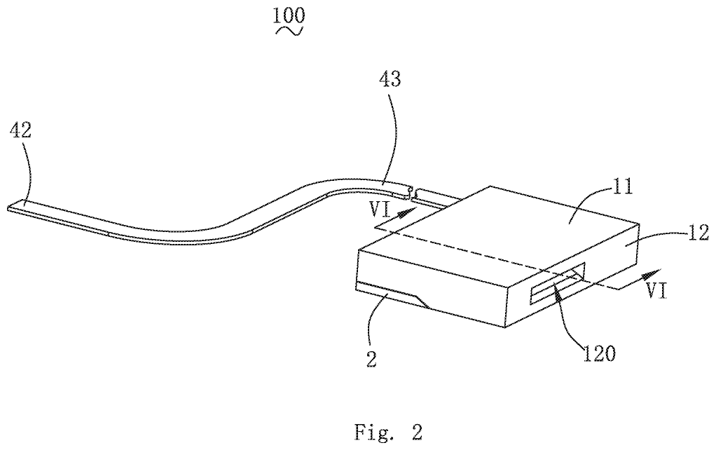

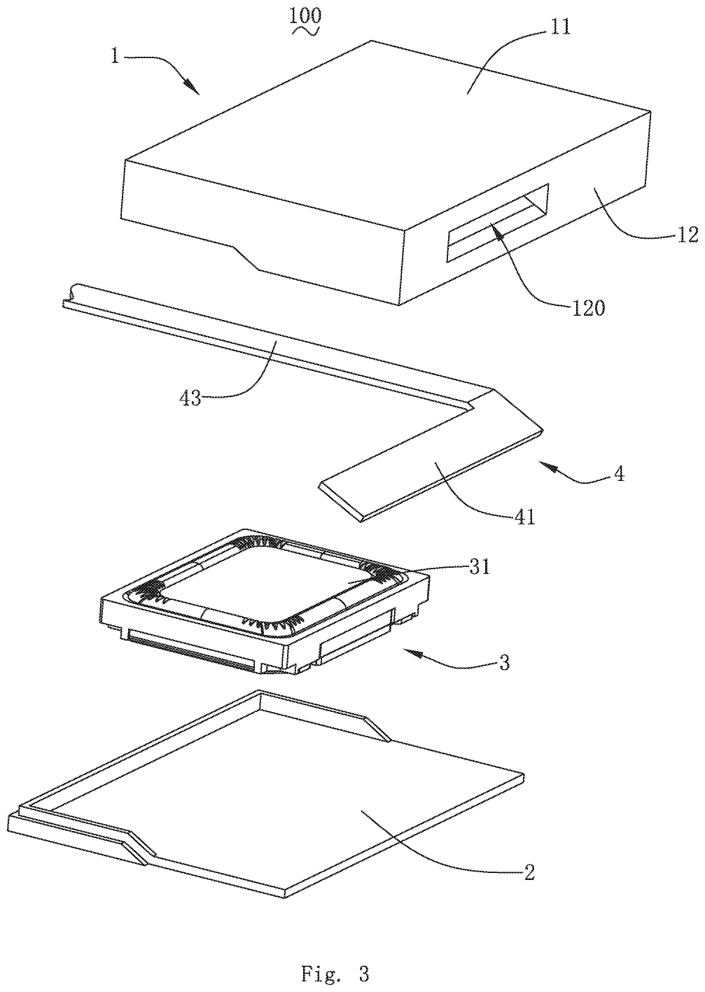

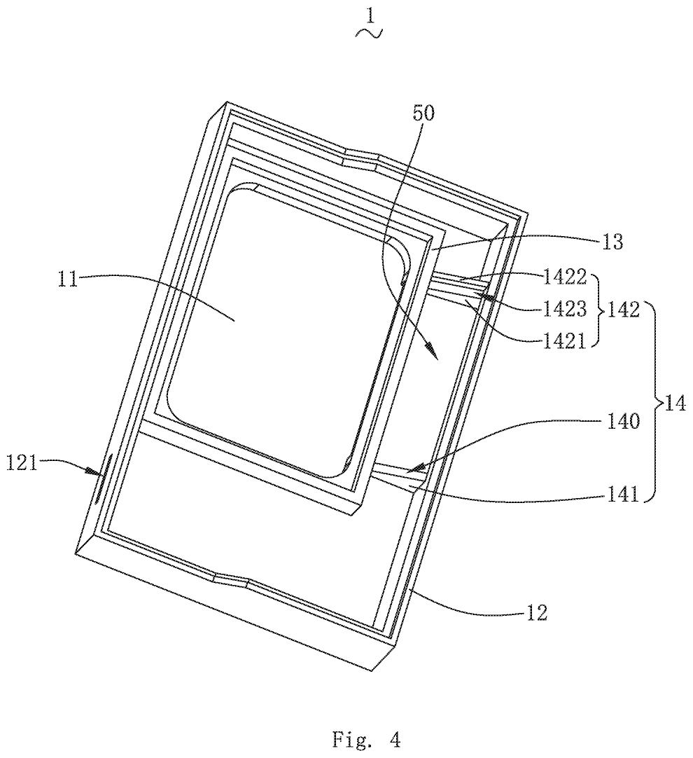

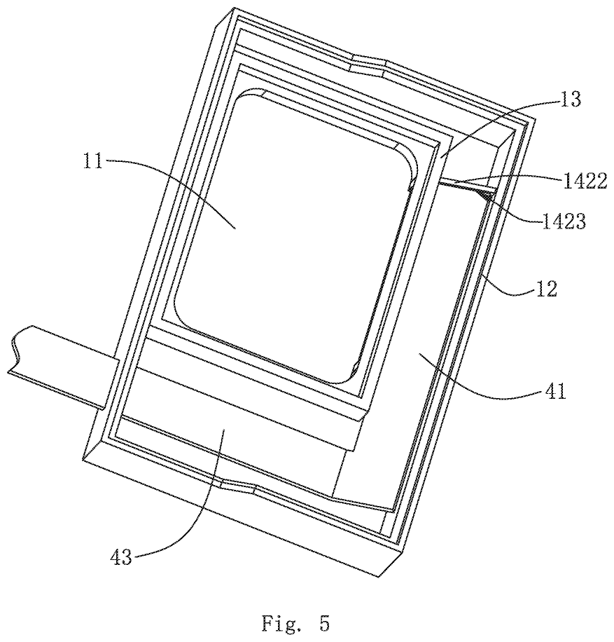

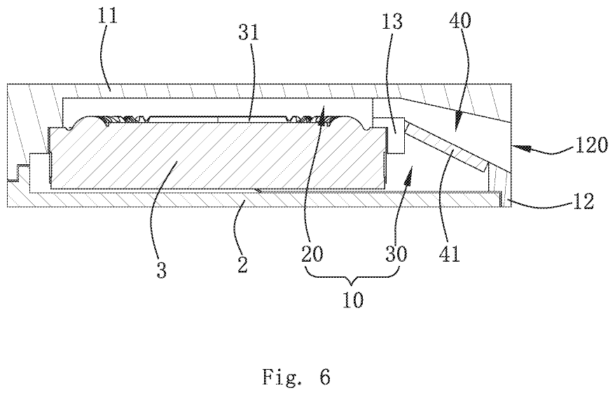

Please refer to FIGS. 1-6, the present application provides a mobile terminal 200. The mobile terminal 200 comprises a housing body 210 with an accommodation space, a heating part member 220 accommodated in the accommodation space and a speaker box 100.

The heating part member 220 can be central processor, battery or PCB. Of course, the heating part member 220 can be other parts that need dissipate heat in the mobile terminal 200.

The speaker box 100 is used for vibrating and sounding and realizes the function of playing music or voice message of the mobile terminal 200 correspondingly. The speaker box 100 comprises an upper cover 1, a lower cover 2 forming a containment space 10 by cooperating with the upper cover 1, a speaker unit 3 with a diaphragm 31 accommodated in the containment space 10 and a heat conductor 4 conducting the heat generated by the heating part member 220 into the speaker box 100.

The containment space 10 comprises a front acoustic cavity 20 formed by the diaphragm 31 and the upper cover 1 in intervals and a back cavity 30 opposite to the front acoustic cavity 20. It can be understood that the back cavity 30 is encircled by the upper cover 1, the lower cover 2, the diaphragm 31 and the heat conductor 4 together.

The upper cover 1 comprises a top wall 11 set opposite to the diaphragm 31, a side wall 12 bending and extending from the edge of the top wall 11 to the direction near the lower cover 2, a support wall 13 extending from the top wall 11 to support the speaker unit 3 and one pair of blocking plates 14 set in intervals by extending and inclining from the side wall 12 to the support wall 13.

A sound outlet 120 connected with the outside and a through hole 121 connected with the accommodation space are set on the side wall 12

The two ends of the blocking plate 14 are respectively butted against the side wall 12 and the support Wall 13, and the height of the blocking plate 14 decreases gradually from the side wall 12 to the support Wall 13. Further, in order to explain the content of the present application more clearly, the two blocking plates 14 are respectively defined as a first blocking plate 141 and a second blocking plate 142 set oppositely. The second blocking plate 142 comprises a body part 1421 and an extension part 1422 extending from the edge one side of the body part 1421 away from a first blocking plate 141 to the direction near the lower cover 2. The projection of the first blocking plate 141 to the second blocking plate 142 coincides with the body part 1421. The heat conductor 4 extends from the back cavity 30 to the blocking plate 14 and is lapped on the blocking plate 14, so that the blocking plate 14, the top wall 11 and the heat conductor 4 jointly form a sound channel 40 connected with the front acoustic cavity 20. The sound outlet 120 is connected with the sound channel 40 for conducting sound to the outside.

Specifically, the heat conductor 4 comprises a heat dissipation part 41 lapped on the blocking plate 14, a heat conduction part 42 connected with the heating part member 220 and a heat transfer part 43 connected with the heat dissipation part 41 and the heat conduction part 42.

One end of the heat dissipation part 41 is lapped on the body part 1421 and butted against the extension part 1422, and the other end is lapped on the first blocking plate 141, so that the heat dissipation part 41, the first blocking plate 141, the second blocking plate 142 and the top wall 11 together form the sound channel 40, a concave groove 1423 formed between the body part 1421 and the extension part 1422 to limit the heat dissipation part 41, limit the movement of the end of the heat dissipation part 41 and improve the stability. At the same time, the extension part 1422 can also be used to locate the installation of the heat conductor 41 and improve the assembly efficiency.

Further, the two blocking plates 14 comprises an inclining surface 140 set inclinedly to the top wall 11. The two blocking plates 14 cooperate with the side wall 12 and the support wall 13 to form an opening 50 connected with the sound channel 40. The heat dissipation part 41 is lapped on the inclining surface 140 and completely covers the opening 50.

It can be understood that the heat dissipation part 41 is lapped on the inclined surface 140, so that the heat dissipation part 141 is also set inclinedly, which increases the heat dissipation area of the heat dissipation part 141, and the heat dissipation effect is better.

One part of the heat transfer part 43 is accommodated in the containment space 10, and the other part is connected with the heat conduction part 42 through the through hole 121. Preferably, the heat conduction part 42, the heat transfer part 43 and the heat dissipation part 41 are integrally formed.

When the mobile terminal 200 operates, the heating part member 220 works to generate heat, and the heat generated by the heating part member 220 is absorbed by the heat conduction part 42, and transmitted to the heat dissipation part 41 through the heat transfer Part 43, which is aggregated in the sound channel 40 and transmitted to the front acoustic cavity 20.

When the mobile terminal 200 operates, the speaker box 100 can perform heat dissipation correspondingly. At this time, a pulse signal of lower frequency is input to the speaker box 100 to drive the diaphragm 31 to vibrate, generate a high-speed airflow, and rapidly export the heat transmitted to the front acoustic cavity 20 through the heat conductor 4 to the outside, so as to reduce the temperature of the heating part member 220. Preferably, the frequency of the pulse signal is lower than 1000 Hz, and the pulse signal at this frequency will only cause the diaphragm 31 to vibrate, but will not emit sound. When the speaker box 100 does not perform the music playing task, the pulse signal can be input separately. When the speaker box 100 performs the task of playing music, the pulse signal can be superposed into the music signal. Because the frequency of the pulse signal is ultra-low frequency, it will not be captured by the human ear and will not affect the normal effect of listening music.

Specifically, when the diaphragm 31 vibrates toward the direction near the upper cover 1, the high-speed airflow will exhaust the heat in the sound channel 40. When the diaphragm 31 vibrates toward the direction near the lower cover 2, the relatively cold outside air will be pumped into the sound channel 40 to form convection and air exchange, which can ensure the air in the sound channel 40 absorbs the heat emitted by the heat dissipation part 41 and maintains a high heat transfer efficiency.

The heat conductor 4 can be a solid structure or a hollow structure, which is not limited by the present application. Preferably, the heat conductor 4 is a hollow structure, which includes a hollow area filled with condensate liquid. The condensate liquid can further improve the heat absorption and heat conduction ability of the heat conductor 4, and further improve the heat conduction ability of the heat conductor 4.

Comparing with the related technologies, in the mobile terminal 200 provided by the present application, the heat generated by the heating part member 220 of the mobile terminal 200 is transmitted to the sound channel 40 through the heat conductor 4 and then to the front acoustic cavity 20, and the heat gathered in the front acoustic cavity 20 is discharged to outside through the vibration of the diaphragm 31 to reduce the temperature of the heating part member 220.

What has been described above is only the embodiment of the present application. It should be pointed out here that for ordinary technicians in this field, improvements can be made without departing from the inventive concept of the present application, but these all belong to the protection scope of the present application.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker box, comprising:
an upper cover;
a lower cover forming a containment space with the upper cover;
a speaker unit accommodated in the containment space, comprising a diaphragm for dividing the containment space into a front acoustic cavity and a back cavity opposite to the front acoustic cavity;
wherein
the upper cover comprises a top wall opposite to the diaphragm, a side wall bending and extending from an edge of the top wall toward the lower cover, a support wall extending from the top wall to support the speaker unit, and one pair of the blocking plates inclining and extending from the side wall to the support wall;
the speaker box further comprises a heat conductor conducting heat generated by a heating part member into the speaker box;
the heat conductor extends from the back cavity to the blocking plate and is lapped on the blocking plate; the top wall and the heat conductor together form a sound channel connecting the front acoustic cavity; and
the heat conductor is used to conduct the heat generated by the heating part member to the sound channel and the front acoustic cavity.

2. The speaker box as described in claim 1, wherein, the back cavity is encircled by the heat conductor, the upper cover, the diaphragm and the lower cover.

3. The speaker box as described in claim 1, wherein, the heat conductor comprises a heat dissipation part lapped on the blocking plate, a heat conduction part connected with the heating part member and a heat transfer part connecting the heat conduction part and the heat dissipation part; a through hole is set on the side wall; one part of the heat transfer part is accommodated in the containment space; the other part is connected with the heat conduction part through the through hole; the heat conduction part, the heat transfer part and the heat dissipation part are integrally formed.

4. The speaker box as described in claim 3, wherein, the two blocking plates comprise an inclined surface set inclinedly to the top wall and the two blocking plates encircle an opening connected with the sound channel with the side wall and the support wall; the heat dissipation part is lapped on the inclined surface and covers the opening completely.

5. The speaker box as described in claim 4, wherein, the blocking plate comprises set oppositely a first blocking plate and a second blocking plate; the second blocking plate comprises a body part and an extension part extending from the edge of one side of the body part away from the first blocking plate to the direction near the lower cover; the body part and the extension part cooperate and form a concave groove limiting the heat dissipation part.

6. The speaker box as described in claim 3, wherein, the heat conductor has a hollow area for receiving condensate liquid.

7. The speaker box as described in claim 3, wherein, the heat conductor is solid structure.

8. The speaker box as described in claim 3, wherein, a sound outlet connected with outside is set on the side wall; the sound outlet is connected with the sound channel used for conducting the sound to outside.

9. A mobile terminal, comprising a housing body with an accommodation space, a heating part member accommodated in the accommodation space and a speaker box as described in claim 1 accommodated in the accommodation space.

10. The mobile terminal as described in claim 9, wherein, the heating part member is a central processor, a battery or PCB.
